(19) United States
(12) Patent Application Publication
(10) Pub. No.: US 2016/0182933 A1
(43) Pub. Date: Jun. 23, 2016

(54) Method and System for Distributing and Playing Media

(71) Applicant: Apostle Innotech L.L.C., Taipei City (TW)

(72) Inventor: Chien-Cheng CHEN, Hsinchu County (TW)

(21) Appl. No.: 14/969,145

(22) Filed: Dec. 15, 2015

(30) Foreign Application Priority Data
Dec. 17, 2014 (TW) 103144057

(51) Int. Cl. H04N 21/262; H04N 21/454; H04N 21/2547; H04N 21/41; H04L 29/08; H04N 21/258

(52) U.S. Cl. CPC H04N 21/262; H04L 67/10; H04N 21/25841; H04N 21/2547; H04N 21/4122; H04N 21/4126; H04N 21/4542

(57) ABSTRACT

A method for distributing and playing media is implemented by a server coupled to a plurality of media-playing devices disposed at respective locations, and capable of communicating with a customer-side electronic device. The customer-side electronic device is able to transmit to the server a media file and a reservation message. In the method, in response to receipt of a confirmation message, the server creates a media playing schedule according to the reservation message, transmits the media file to one of the media-playing devices indicated by the media playing schedule, and controls the one of the media-playing devices to play the media file in a time slot on a date according to the media playing schedule.

### CROSS-REFERENCE TO RELATED APPLICATION

This application claims priority of Taiwanese Application No. 103144057, filed on Dec. 17, 2014.

### FIELD

The disclosure relates to a method and a system for distributing and playing media.

### BACKGROUND

An electronic billboard is typically placed in a public location for displaying media such as a digital image, a video, etc. The media to be displayed by the electronic billboard is typically provided by a storage device (e.g., a memory card) that is removably attached to the electronic billboard. When it is intended to change the media to be displayed, the storage device may be replaced.

In related art, Taiwanese Patent No. M486216 discloses a server system for managing an electronic billboard using a remotely coupled server, operated by an operator on behalf of the owner of the electronic billboard.

### SUMMARY

An object of the disclosure is to provide a method that allows a customer to interact with a server for distributing a media file to at least one remotely coupled media playing device, and enabling the media playing device to play the media file.

According to the disclosure, the method is for distributing and playing media, and is to be implemented by a server. The server is coupled to a plurality of media-playing devices and is capable of communicating with a customer-side electronic device. The media-playing devices are disposed at respective locations. The customer-side electronic device is configured to transmit, to the server, a media file and a reservation message. The reservation message specifies a date, a time slot and one of the locations of the media-playing devices. The method includes the steps of:

a) in response to receipt of a confirmation message that indicates a payment associated with the customer-side electronic device has been processed, automatically creating a media playing schedule according to the reservation message; and

b) according to the media playing schedule, transmitting the media file to one of the media-playing devices that corresponds to said one of the locations, and controlling said one of the media-playing devices to play the media file in the time slot on the date.

Another object of the disclosure is to provide a system that is capable of implementing the abovementioned method.

According to the disclosure, the system is for distributing and playing media and includes a server and a plurality of media-playing device.

The server that is capable of communicating with a customer-side electronic device. The customer-side electronic device is configured to transmit, to the server, a media file and a reservation message. The reservation message specifies a date, a time slot and one of the locations of the media-playing devices.

The media-playing devices are coupled to the server. Each of the media-playing devices is disposed at respective locations.

In response to receipt of a confirmation message that indicates a payment associated with the customer-side electronic device has been processed, the server is programmed to:

automatically create a media playing schedule according to the reservation message; and

transmit the media file to one of the media-playing devices that corresponds to the one of the locations according to the media playing schedule, and control the one of the media-playing devices to play the media file in the time slot on the date.

### BRIEF DESCRIPTION OF THE DRAWINGS

Other features and advantages of the disclosure will become apparent in the following detailed description of the embodiments with reference to the accompanying drawings, of which:

FIG. 1 illustrates a system for distributing and playing media, according to one embodiment of the disclosure;

FIG. 2 is a block diagram illustrating the components of the system, according to one embodiment of the disclosure;

FIG. 3 is a flowchart illustrating steps of a method for illustrates a system for distributing and playing media, according to one embodiment of the disclosure; and

FIG. 4 illustrates a menu that is to be displayed on a customer-side electronic device.

### DETAILED DESCRIPTION

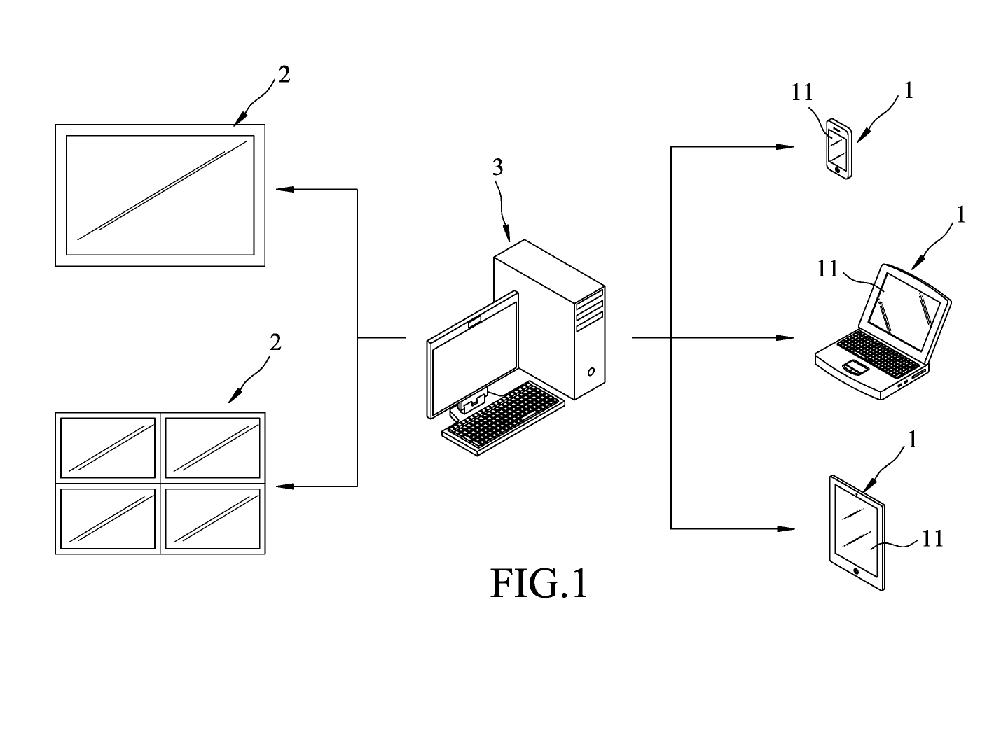

FIG. 1 illustrates a system for distributing and playing media according to one embodiment of the disclosure. The system includes a server 3 and a plurality of media-playing devices 2 coupled to the server 3. The server 3 is capable of communicating with a customer-side electronic device 1.

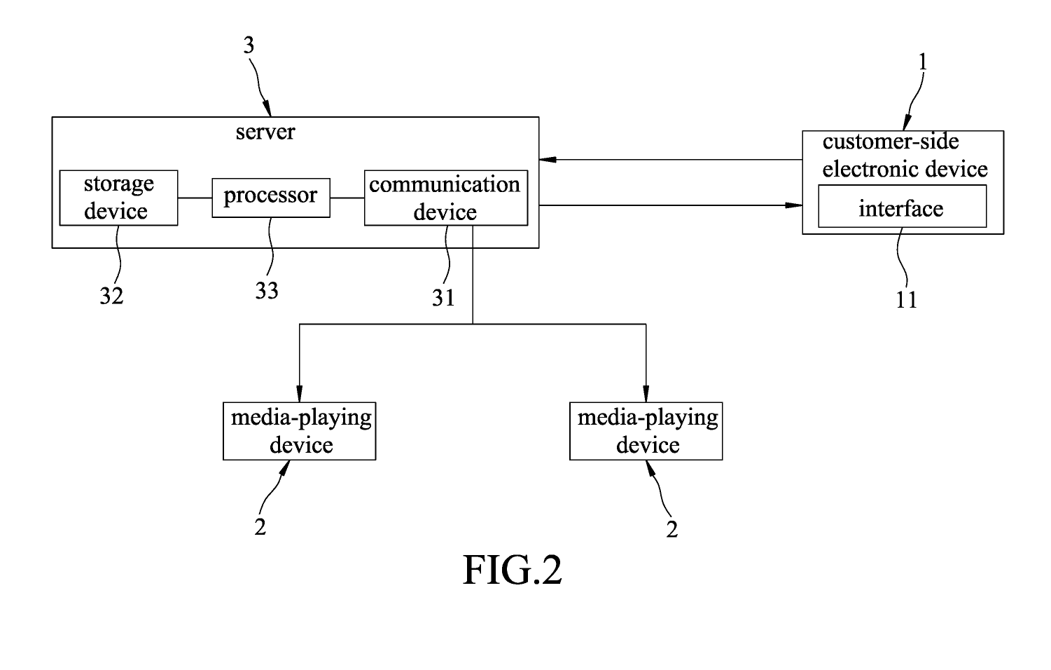

Further referring to FIG. 2, the customer-side electronic device 1 in this embodiment may be embodied using, for example, a handheld mobile device, a personal computer, a laptop computer, a tablet computer, etc. The customer-side electronic device 1 includes an interface 11 (such as a keyboard/mouse combination and a display, a touch screen, etc.) that allows a user to interact with the customer-side electronic device 1.

The customer-side electronic device 1 may be installed with an application that, when executed, controls the customer-side electronic device 1 to establish a connection with the server 3 (e.g., via a network). Alternatively, the customer-side electronic device 1 maybe provided with a Uniform Resource Locator (URL) that directs the customer-side electronic device 1 to a website that is associated with the server 3, thereby being able to communicate with the server 3.

Afterward, the customer-side electronic device 1 may interact with the server 3 in order to enable one or more of the media-playing devices 2 to play a media file.

In this embodiment, the media-playing devices 2 are each embodied using an electronic display screen, and are disposed at respective locations. For examples, the media-playing devices 2 may be disposed at different street blocks of a city.

The media file maybe in the form of a text, an image, a photo, a sound clip, an animation, a video, or a combination thereof.

The server 3 is coupled to the media-playing devices 2, and includes a communication device 31, a storage device 32, and a processor 33.

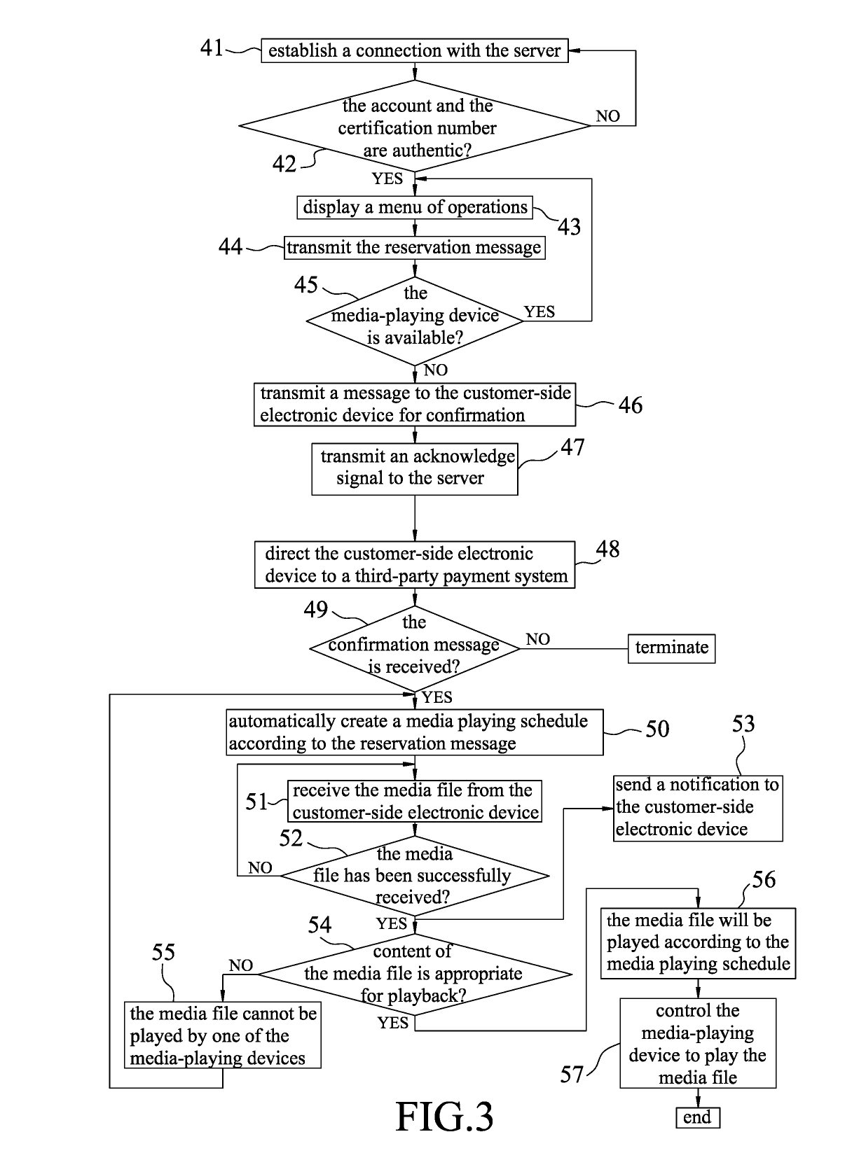

FIG. 3 illustrates steps of a method for distributing and playing media according to one embodiment of the disclosure. The method may be implemented by the system described above.

In step 41, the user of the customer-side electronic device 1 may attempt to establish a connection with the server 3. This may be done in the ways described above (e.g., using an application and/or a URL).

As a result, in step 42, the interface 11 of the customer-side electronic device 1 may display a webpage that enables the customer-side electronic device 1 to perform specific operations. At this stage, the webpage may instruct the user to input an account and a certification number, for the purpose of identification.

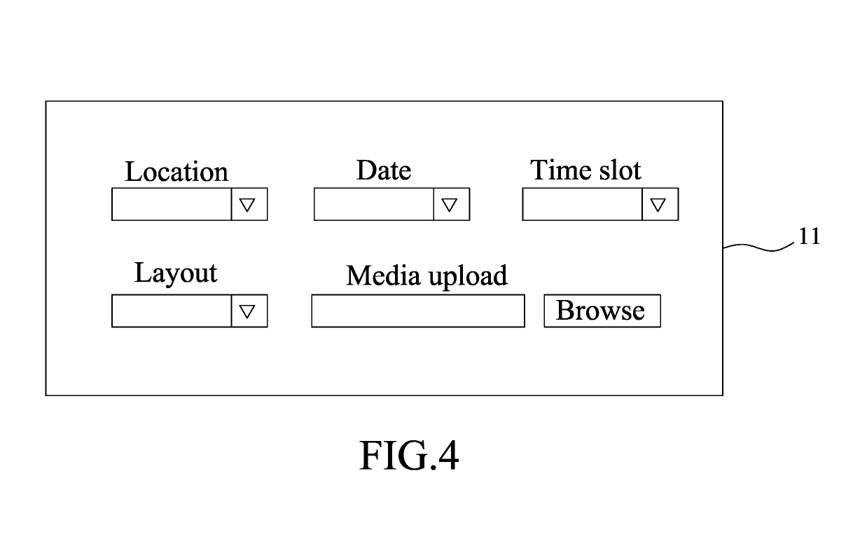

After it is determined that the account and the certification number are authentic, the server 3 controls the webpage to display a menu of operations in step 43. Referring to FIG. 4, the menu may include a list of locations, a list of dates, and a list of time slots.

The menu enables input of the user's preference as to which one(s) of the locations the media file is to be played at, and which date and time slot the media file is to be played in. The user may then operate the customer-side electronic device 1 to select the specific location(s), date and time slot. For example, in this embodiment a specific location (LongBon Building, Taichung), a specific date (Dec. 31, 2014), and a specific time slot (10:00 to 11:00) may be selected. In another embodiment, another set of specific location, date, and time slot (ShinBow Building, Taipei, Jan. 15, 2015, 15:00 to 16:00) may be selected.

In one embodiment, the menu may further include a layout option so as to allow the user to specify how the media file is to be played. For example, when the selected one of the media-playing devices 2 includes more than one screen, the user may designate one or more of the screens for playing the media file.

Afterward, in step 44, the customer-side electronic device 1 generates a reservation message that specifies the location, the time slot and the date selected by the user, and optionally, the layout, and transmits the reservation message to the server 3.

Upon receiving the reservation message, in step 45, the server 3 determines whether one of the media-playing devices 2, disposed at the location selected by the user, is available in the time slot on the date specified by the user.

When it is determined that the one of the media-playing devices 2 selected by the user is available in the time slot on the date, the flow proceeds to step 46. Otherwise, the flow goes back to step 43.

In step 46, the server 3 transmits a message to the customer-side electronic device 1 for confirmation. The message may include a disclaimer.

In step 47, after the user operates the customer-side electronic device 1 to acknowledge the message (and therefore agreeing to the clauses of the disclaimer), the customer-side electronic device 1 transmits an acknowledge signal to the server 3.

In response, in step 48, the server 3 directs the customer-side electronic device 1 to a third-party payment system for processing a payment associated with allowing the media file to be played by the one of the media-playing devices 2.

In this embodiment, the payment may be done using, for example, automated teller machine (ATM) transfer, wire transfer, credit card, and other third-party payment system (e.g., PayPal, Apple Pay, Google Wallet, Alipay, etc.). After the payment has been processed, the third-party payment system generates a confirmation message, and transmits the confirmation message to the server 3.

In step 49, the server 3 determines whether the confirmation message is received. In response to receipt of the confirmation message, the flow proceeds to step 50.

When it is determined that the confirmation message has not been received after a predetermined time period (e.g., 60 minutes), the entire process maybe terminated by the server 3.

In step 50, the server 3 automatically creates a media playing schedule according to the reservation message. Specifically, the media playing schedule indicates that the selected one of the media-playing devices 2 will be reserved to play the media file that is to be provided by the user. The media playing schedule is then stored in the storage device 32.

The webpage displayed by the interface 11 at this stage may ask the user to upload the media file to the server 3. In step 51, the server 3 receives the media file from the customer-side electronic device 1 and stores the media file in the storage device 32.

After determining that the media file has been successfully received in step 52, the server 3 sends a notification to the customer-side electronic device 1 in step 53 via a push alert, an email and/or a text message.

Meanwhile, in step 54, the processor 33 of the server 3 performs a content checking process to determine whether content of the media file is appropriate for playback. Specifically, in this embodiment, the processor 33 checks whether the media file contains contents such as profanities, nudity and/or sexual content.

Accordingly, the processor 33 may determine whether the content of the media file includes a word string that is included in a language filter list stored in the server 3, or whether an image of the content of the media file contains nudity, e.g., by determining whether the image has a portion that is larger than a pre-determined threshold area and that is covered in a human skin color. It is noted that there may be other ways of confirming whether the image involves nudity. When at least one of the conditions is met, the processor 33 determines that the content of the media file is inappropriate for playback. In such a case, the flow proceeds to step 55.

In step 55, the server 3 transmits a message to the customer-side electronic device 1 indicating that the media file received therefrom cannot be played by one of the media-playing devices 2 due to inappropriate content. The flow may then go back to step 50 to instruct the user to re-submit another media file. In another embodiment, the webpage may be provided with a refund option that allows the user to withdraw from the method, thereby terminating the method.

On the other hand, when no inappropriate content is found in the media file, the flow proceeds to step 56. In step 56, the server 3 notifies the customer-side electronic device 1 that the media file will be played according to the media playing schedule.

Afterward, in step 57, the server 3 transmits the media file to the one of the media-playing devices 2 that corresponds to the one of the locations according to the media playing schedule, and controls the one of the media-playing devices 2 to play the media file in the time slot on the date.

To sum up, the method and the system as described in the disclosure provide a way for allowing the user to easily communicate with the server 3 so as to facilitate distribution and playing of the media file.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for distributing and playing media, the method being to be implemented by a server that is coupled to a plurality of media-playing devices and that is capable of communicating with a customer-side electronic device, the media-playing devices being disposed at respective locations, the customer-side electronic device being configured to transmit to the server a media file, and a reservation message that specifies a date, a time slot and one of the locations of the media-playing devices, the method comprising the steps of:
a) in response to receipt of a confirmation message indicating that a payment associated with the customer-side electronic device has been processed, automatically creating a media playing schedule according to the reservation message; and
b) according to the media playing schedule, transmitting the media file to one of the media-playing devices that corresponds to said one of the locations, and controlling said one of the media-playing devices to play the media file in the time slot on the date.

2. The method of claim 1, wherein step a) includes the sub-steps of:
upon receiving the reservation message, determining whether said one of the media-playing devices is available in the time slot on the date;
when it is determined that said one of the media-playing devices is available in the time slot on the date, directing the customer-side electronic device to a third-party payment system for processing the payment;
upon receiving the confirmation message, automatically creating the media playing schedule according to the reservation message.

3. The method of claim 1, further comprising the step, before the reservation message is received from the customer-side electronic device, of allowing the customer-side electronic device to access the server in response to receipt of an account and a certification number from the customer-side electronic device.

4. The method of claim 1, the customer-side electronic device being installed with an application, wherein the method further comprises the step of enabling the customer-side electronic device through the application to display a user interface allowing a user to set said one of the locations, the date and the time slot.

5. The method of claim 1, further comprising the step, after the media file is received from the customer-side electronic device, of performing a content checking process to determine whether content of the media file is appropriate for playback,
wherein the server implements step b) when it is determined that the content of the media file is appropriate for playback.

6. The method of claim 5, wherein in the content checking process, the server determines that the content of the media file is inappropriate for playback when at least one of the following conditions is met:
the content of the media file includes a word string that is included in a language filter list stored in the server; or
an image of the content of the media file contains nudity.

7. The method of claim 5, further comprising the step of sending a notification to the customer-side electronic device when it is determined in the content checking process that the media file is inappropriate for playback.

8. The method of claim 5, further comprising the step of notifying the customer-side electronic device that the media file will be played according to the media playing schedule when it is determined in the content checking process that the media file is appropriate for playback.

9. The method of claim 1, further comprising the step of sending a notification to the customer-side electronic device after the media file is successfully received therefrom.

10. A system for distributing and playing media, comprising:
a server that is capable of communicating with a customer-side electronic device; and
a plurality of media-playing devices coupled to said server, each of said media-playing devices being disposed at respective locations,
the customer-side electronic device being configured to transmit to said server a media file, and a reservation message that specifies a date, a time slot and one of the locations of said media-playing devices;
wherein, in response to receipt of a confirmation message indicating that a payment associated with the customer-side electronic device has been processed, said server is programmed to
automatically create a media playing schedule according to the reservation message, and
transmit the media file to one of said media-playing devices that corresponds to said one of the locations according to the media playing schedule, and control said one of said media-playing devices to play the media file in the time slot on the date.

11. The system of claim 10, wherein:
upon receiving the reservation message, said server is programmed to determine whether said one of said media-playing devices is available in the time slot on the date;
when it is determined that said one of said media-playing is available in the time slot, said server is programmed to direct the customer-side electronic device to a third-party payment system for processing the payment;
upon receiving the confirmation message, said server is programmed to automatically create the media playing schedule according to the reservation message.

12. The system of claim 10, wherein said server is programmed to allow, before receiving the reservation message from the customer-side electronic device, the customer-side electronic device to access said server in response to receipt of an account and a certification number from the customer-side electronic device.

13. The system of claim 10, the customer-side electronic device being installed with an application, wherein the said server is programmed to enable the customer-side electronic device through the application to display a user interface allowing a user to set said one of the locations, the date and the time slot.

14. The system of claim 10, wherein after the media file is received from the customer-side electronic device, said server is programmed to perform a content checking process to determine whether content of the media file is appropriate for playback, and
wherein said server is programmed to transmit the media file to the one of said media-playing devices when it is determined that the content of the media file is appropriate for playback.

15. The system of claim 14, wherein in the content checking process, said server determines that the content of the media file is inappropriate for playback when at least one of the following conditions is met:
the content of the media file includes a word string that is included in a language filter list stored in said server; or
an image of the content of the media file contains nudity.

16. The system of claim 14, wherein when it is determined by said server in the content checking process that the media file is inappropriate for playback, said server is programmed to send a notification to the customer-side electronic device.

17. The system of claim 14, wherein when it is determined in the content checking process that the media file is appropriate for playback, said server is programmed to notify the customer-side electronic device that the media file will be played according to the media playing schedule.

18. The system of claim 10, wherein, after the media file is successfully received therefrom, said server sends a notification to said customer-side electronic device.
